(19) United States
(12) Patent Application Publication
(10) Pub. No.: US 2025/0118069 A1
(43) Pub. Date: Apr. 10, 2025

(54) SYSTEMS AND METHODS FOR ENHANCED UTILITY LINE AND POLE DETECTION, CLASSIFICATION, AND INSPECTION USING LIDAR POINT CLOUD DATA

(71) Applicant: Osmose Utilities Services, Inc., Atlanta, GA (US)

(72) Inventors: Randal K. More, Atlanta, GA (US); Brian Reed, Atlanta, GA (US); John Ware, Atlanta, GA (US)

(21) Appl. No.: 18/376,578

(22) Filed: Oct. 4, 2023

(51) Int. Cl. G06V 20/10; G01S 17/89; G06T 3/40; G06T 7/70

(52) U.S. Cl. CPC G06V 20/176; G01S 17/89; G06T 3/4023; G06T 7/70

(57) ABSTRACT

Systems and methods for evaluating utility infrastructure using LIDAR data by dynamically capturing and processing the LIDAR data for improved assessment accuracy and processing efficiency. The method includes determining an orientation of a mobile LIDAR system, dynamically capturing LIDAR data corresponding to a region of interest by collecting LIDAR samples based on the orientation and the region of interest, identifying a utility object based at least in part on the LIDAR samples, decimating the LIDAR samples within a predetermined area around the utility object, generating depth-encoded multi-perspective images of the utility object using the decimated LIDAR samples, and determining at least one condition of the utility object. Certain implementations include determining a speed and an orientation of a mobile LIDAR system and dynamically capturing position data corresponding to a region of interest by collecting LIDAR samples at a rate based on the speed, the orientation, and the region of interest.

### BACKGROUND

Light Detection and Ranging (LIDAR) scanning is a remote sensing method that utilizes pulsed laser light, scanner optics, and a receiver/photodetector to infer distance by measuring the time-of-flight for pulsed laser light to reflect from objects of interest and return to the receiver. A 3-D point cloud acquired from a LIDAR scanner can be matched with a digital image taken from the scanner's location to create a realistic 3-D model of structures in the local environment.

Existing LIDAR methods can provide information that is generally sufficient to perform measurements of objects from a remote location. Thus, in some applications, such as autonomous vehicle applications, LIDAR has been used to determine whether an object is present (e.g., whether an object is in front of the autonomous vehicle). However, it has proven difficult for LIDAR systems alone to identify or classify objects. LIDAR systems, for example, can generally detect the presence of an object, but determining what type of object has been detected has been a signification challenge for existing LIDAR systems.

As disclosed in U.S. Patent Application Publication US20230243976, assigned to Osmose Utilities Services Inc., and fully incorporated herein by reference, processing certain mobile LIDAR data of scanned real-world objects has been proposed for evaluating utility systems (such as utility poles and associated cables) for repairs, expansion, etc. The technological advancements discussed herein may provide certain enhancements in accuracy, processing speed, and/or memory utilization to improve the efficiency and usefulness of the systems and methods provided in the above-referenced disclosure.

One of the difficulties encountered when working with mobile LIDAR scanning and modeling is that the generated point cloud data can be extremely dense, difficult to process, and expensive to store. A standard solution to address such issues can involve decimation where a portion of the data points can be removed to simplify the processing and storage.

Forms of decimation include statistical removal (remove every N point), Gaussian removal (each point is removed based on the outcome of a random number generator), applying a voxel grid filter (divide a point cloud into a three-dimensional grid of adjustable cubes and keep only one point per cube), uniform sampling filter (select a subset of points from the point cloud that are evenly distributed throughout the space), progressive morphological filter (remove points based on their local curvature), and/or distance-based filter (remove points that are too close together). Such algorithms can result in uniform decimation and/or can maintain the spatial distribution of the original point cloud, but they may be computationally expensive and can result in useful information being thrown out when data points are removed. Furthermore, decimation doesn't address certain positional errors that can arise in the point cloud data, for example, that result when a mobile LIDAR scanner is attached to a vehicle or drone that accelerates, decelerates, rapidly changes directions, or otherwise moves with high variability.

Accordingly, there is a need for improved remote sensing systems and processing methods that increase the accuracy, consistency, speed, efficiency, and/or cost-effectiveness of 3D modeling of mobile LIDAR scanning data.

### BRIEF SUMMARY

Systems and methods are disclosed herein for improvements in dynamically capturing, processing, and/or utilizing LIDAR point cloud data for detecting and evaluating utility objects of interest.

In accordance with certain exemplary implementations of the disclosed technology, a method is provided for dynamically capturing and processing utility infrastructure LIDAR data for improved assessment accuracy and processing efficiency. The method can include determining an orientation of a mobile LIDAR system; dynamically capturing, with the mobile LIDAR system, LIDAR data corresponding to a region of interest by collecting LIDAR samples based on the orientation and the region of interest; identifying a utility object based at least in part on the LIDAR samples; decimating the LIDAR samples within a predetermined area around the utility object; generating depth-encoded multi-perspective images of the utility object using the decimated LIDAR samples; and determining at least one condition of the utility object.

In accordance with certain exemplary implementations of the disclosed technology, a non-transitory computer-readable storage medium storing instructions that are configured to cause one or more processors to perform a method determining an orientation of a mobile LIDAR system; dynamically capturing, with the mobile LIDAR system, LIDAR data corresponding to a region of interest by collecting LIDAR samples based on the orientation and the region of interest; identifying a utility object based at least in part on the LIDAR samples; decimating the LIDAR samples within a predetermined area around the utility object; generating depth-encoded multi-perspective images of the utility object using the decimated LIDAR samples; and determining at least one condition of the utility object.

In accordance with certain implementations, another method is disclosed herein that includes determining a speed and an orientation of a mobile LIDAR system; dynamically capturing, with the mobile LIDAR system, position data corresponding to a region of interest by collecting LIDAR samples at a rate based on the speed, the orientation, and the region of interest; compensating at least a portion of the position data based on one or more of the speed and orientation to correct position errors; capturing, with a camera, one or more images of the region of interest; determining one or more locations and directions of the camera corresponding to the capturing of the one or more images; determining, based on the one or more locations and directions of the camera and the one or more captured images, a location of a utility object; decimating the LIDAR samples within a selectable or predetermined area at or around the location of the utility object; generating depth-encoded multi-perspective images of the utility object using the decimated LIDAR samples; assessing at least one condition of the utility object; and outputting a work order based on the assessing.

A system is disclosed herein for dynamically capturing utility infrastructure LIDAR data. The system can include one or more of: a LIDAR data capture module configured to dynamically capture position data corresponding to a region of interest by collecting LIDAR samples; a speed detector configured to determine a speed of the vehicle or the LIDAR data capture module; an orientation detector configured to determine an orientation of the LIDAR data capture module; a GPS module configured to determine a location of the system; and a LIDAR acquisition control module configured to interface with the LIDAR data capture module to dynamically control a rate of collecting the LIDAR samples based on the speed, the orientation, and the determined location relative to the region of interest.

In accordance with another aspect of the disclosed technology, a system is provided for evaluating utility infrastructure LIDAR data. The system can include one or more processors; memory in communication with the one or more processors and storing instructions that when executed by the one or more processors, cause the system to one or more of: receive LIDAR samples corresponding to a selectable or predetermined area at or around a location of a utility object; receive one or more captured images of the selectable or predetermined area, each of the one or more captured images including metadata comprising location data and direction data corresponding to a sampling position of the LIDAR samples; determine, based on the location data, the direction data, and the one or more captured images, a location of a utility object; decimate the LIDAR samples within a selectable or predetermined area at or around the determined location of the utility object; generate depth-encoded multi-perspective images of the utility object using the decimated LIDAR samples; and assess at least one condition of the utility object. When the utility object is assessed as requiring service, repair, or replacement, the system may output a work order to service the utility object based on the assessing.

Certain implementations of the disclosed technology will now be described with the aid of the following drawings and the detailed description.

### BRIEF DESCRIPTION OF THE FIGURES

Reference will now be made to the accompanying figures and flow diagrams, which are not necessarily drawn to scale.

FIG. 1A illustrates an example LIDAR/camera system installed on a terrestrial vehicle, in accordance with the disclosed technology.

FIG. 1B illustrates an example LIDAR/camera system installed on example drone, in accordance with the disclosed technology.

FIG. 2 illustrates a component diagram of an example LIDAR/camera system, in accordance with the disclosed technology.

FIG. 3A illustrates an example image of an unclassified scene taken by a camera system of an example LIDAR/camera system, in accordance with the disclosed technology.

FIG. 3B illustrates an example processed, classified, filtered, and reconstructed image of the scene shown in FIG. 3A in which LIDAR data is utilized and processed to identify and emphasize utility objects in the scene.

FIG. 4 illustrates an example utility pole with associated cabling, related components, and nearby objects that may be imaged and analyzed for servicing, in accordance with the disclosed technology.

FIG. 5 illustrates a flowchart of an example process for capturing and processing LIDAR data to identify and assess objects, in accordance with the disclosed technology.

FIG. 6 illustrates a divided grid top-view aerial photograph with an associated 3D rendering of a utility object shown in one of the selectable grid regions, in accordance with certain implementations of the disclosed technology.

FIG. 7 illustrates a generation of multi-view 2D image generation from a 3D rendering of a utility object in accordance with certain exemplary implementations of the disclosed technology.

FIG. 8A depicts a top-view representation of a plane vector N corresponding to a plane, in accordance with certain exemplary implementations of the disclosed technology.

FIG. 8B depicts a 3D view of a plane vector N of a plane (as illustrated in FIG. 3A), in accordance with certain exemplary implementations of the disclosed technology.

FIG. 9A illustrates a top-view vertical elevation information encoding process in which depth information of a 3D rendering may be encoded as a “z-axis” value for creating multi-view images, in accordance with certain exemplary implementations of the disclosed technology.

FIG. 9B illustrates a simulated camera viewpoint for a particular 3D rendering of a utility object in accordance with certain exemplary implementations of the disclosed technology.

FIG. 10 shows examples of actual images created from point cloud grids, according to certain implementations of the disclosed technology.

FIG. 11 illustrates object detection, classification, and filtering for grids that contain a pole, in accordance with certain exemplary implementations of the disclosed technology.

FIG. 12 illustrates a flowchart of an example method, in accordance with the disclosed technology.

FIG. 13 illustrates a flowchart of another example method, in accordance with the disclosed technology.

The disclosed technology will now be described using the detailed description in conjunction with the drawings and the attached claims.

### DETAILED DESCRIPTION

The disclosed technology includes systems and methods that can enable certain improvements in the use of Light Detection and Ranging (LIDAR) for utility infrastructure inspection and evaluation. The systems and methods discussed herein can improve LIDAR data processing speed, memory utilization, and accuracy while providing practical utilization enhancements in the capturing, processing, analyzing, modeling, identification, and classification of images and LIDAR data. Certain implementations of the disclosed technology may ultimately be used for improving inspection and evaluation of utility-related objects such as utility poles, cables, etc.

The disclosed technology includes technical improvements that can be utilized in one or more of the following four general stages associated with utility object inspection, including but not limited to (1) the capturing of LIDAR and/or image data while correcting for speed, acceleration, and orientation of the vehicle or drone to which the LIDAR imaging system is attached; (2) selectively decimating the LIDAR data so that it can be efficiently processed and utilized; (3) utilizing a trained model to identify and/or classify utility objects of interest; and/or (4) automatically evaluating the condition of utility objects to determine if they require relocation, service, maintenance, replacement, etc.

Certain implementations of the disclosed technology can include LIDAR mapping that involves a grid map generation process where an array of cells may be divided into grids that can store an object's positional information. A radial distance and z-coordinates from a LIDAR scan, for example, may be used to identify which 3-D points correspond to each of the specified grid cells corresponding to the object.

Certain implementations of the disclosed technology may utilize a LIDAR imaging system to capture (and/or to process and utilize previously captured) LIDAR data and image data, identify one or more objects from the image data, map the LIDAR data to corresponding image data, and/or determine one or more measurements based at least in part on the LIDAR data for at least one of the identified objects. The various practical applications of the disclosed technology can include determining locations, loads, clearances, available space, etc., associated with the identified utility object(s).

Utility object and/or infrastructure analysis typically requires inventorying utility poles, cables, installed components, surrounding man-made and natural structures, surrounding vegetation, etc. This inventorying process can be an arduous, difficult, time-consuming, and/or expensive task, and can be even more difficult if the utility objects of interest are in remote regions. Certain implementations of the disclosed technology may be utilized to address such challenges.

As will be appreciated, the disclosed technology can include, but is not limited to, systems and methods for performing utility pole loading analysis. The disclosed technology can be useful in any application or scenario in which LIDAR data is mapped to image data and/or for which the LIDAR data may be utilized to classify objects or aspects identified from the mapped image data. Certain implementations of the disclosed technology include systems and methods configured to classify, identify, and/or evaluate objects represented by LIDAR data.

Certain implementations of the disclosed technology can include capturing LIDAR data while dynamically correcting positional errors of the LIDAR data by utilizing factors including the speed, acceleration, and orientation of a LIDAR-mounted vehicle, as discussed in W. Yang, Z. Gong, B. Huang and X. Hong, “Lidar With Velocity: Correcting Moving Objects Point Cloud Distortion From Oscillating Scanning Lidars by Fusion With Camera,” IEEE Robotics and Automation Letters, vol. 7, no. 3, pp. 8241-8248, July 2022, (“Yang, et al.”) which is incorporated herein by reference as if presented in full.

Certain implementations of the disclosed technology can include adjusting the data collection rate to control point cloud density. Certain implementations of the disclosed technology can include dynamically decimating the LIDAR data based on points of interest, wherein the dynamic decimation can employ voxel decimation, for example, to limit the number of points per grid square.

Certain implementations may utilize a dynamic octree spatial index in conjunction with a-priori knowledge of the geometry of structures to optimize LIDAR point selection. For example, a-priori location and/or identification data obtained from a geographical information system (GIS) may be utilized by the system to bypass or enhance certain processing-intensive identification and/or classification steps. In certain implementations, regions or objects of interest may be identified by utilizing GIS data and/or camera images, and the LIDAR system may use such information to adjust sampling density in certain regions. For example, pre-decimation may be applied to areas surrounding regions of interest to reduce the number of samples and associated processing needed to facilitate utility equipment identification/classification/evaluation.

In certain example embodiments, a comparison of newly captured data with previous data from a GIS system may be utilized to evaluate corresponding changes to the utility object(s) to determine if an issue needs to be addressed. Furthermore, the newly captured image and/or LIDAR data may be utilized to update the GIS data to provide current information. In certain implementations, GIS history data may be utilized to view/evaluate changes of the utility object(s) over time. For example, an increased sag in a power line over time may indicate that there is an issue with a nearby utility pole.

In certain implementations, precise location of utility objects and/or surrounding objects may be identified may be implemented using precise point positioning (PPP). PPP is a global navigation satellite system (GNSS) positioning method that calculates very precise positions, with errors as small as a few centimeters under optimal conditions. Certain implementations of the disclosed technology may utilize a GNSS receiver, a temporarily fixed base receiver in the field, and a nearby mobile receiver to implement PPP, particularly for determining the precise location of the camera system and/or the LIDAR system while capturing images and/or LIDAR scans.

In certain implementations, processed LIDAR data may be stored in in a “las” format, for example, by converting 64-bit LIDAR data points at or near grid center points to 32-bit data. In certain implementations, the disclosed technology may store the processed data as a binary large object (BLOB). Certain implementations of the disclosed technology can include generating depth-encoded multi-perspective images from point cloud segments.

Certain implementations can include removing ground from images, for example, using a cloth simulation filter (CSF) algorithm. CSF is a tool that extracts ground points from discrete return LIDAR point clouds. CSF is based on cloth simulation, which is a 3D computer graphics algorithm that simulates cloth within a computer program. CSF may be used to simulate the interactions between cloth nodes and the corresponding LIDAR points. The locations of the cloth nodes can be determined to generate an approximation of the ground surface.

In accordance with certain exemplary implementations of the disclosed technology, a CSF algorithm may be utilized to turn an original point cloud upside down, and a simulated fabric may fall on the inverted surface from above, dividing the point clouds into ground and non-ground parts so that the ground parts may be removed. Certain details of the CSF algorithm can be found in W. Zhang, J. Qi, P. Wan, H. Wang, D. Xie, X. Wang, and G. Yan, “An Easy-to-Use Airborne LiDAR Data Filtering Method Based on Cloth Simulation,” Remote Sens., vol. 8, no. 6, p. 501, 2016, which is incorporated herein by reference, as if presented in full.

In certain implementations, images may be scaled to a predefined resolution. In certain implementations, images may be encoded using grayscale with color mapping of color space hue saturation value (HSV) to represent a z-coordinate position. In certain implementations, one or more machine learning models may be utilized for classification and object detection. Accordingly, data from sub-regions of a multi section grid (such 1-meter regions in a 3-section grid for example) may be processed using a machine learning model (such as YOLO) to identify the presence of a pole. In certain implementations, object detection may be utilized to determine precise pole positions. Certain implementations of the disclosed technology include creating a full 3D model of each pole for various utility assessments.

The machine learning models described herein can include models that are initially trained based on feedback from a user. For example, a user can provide feedback to the machine learning model indicative of which image data or portion of image data is representative of a pole or other identified components or objects. The machine learning model can then use that feedback to refine its algorithm to more accurately detect and classify components or objects. Once the machine learning model is sufficiently trained, the machine learning model can be configured to operate largely without user feedback to implement the technology disclosed herein. From time to time, a user may review the output of the machine learning model and provide additional feedback as necessary to further train the machine learning model and/or to ensure the machine learning model remains accurate. The machine learning model can include, but is not limited to, various types of machine learning models and variations of machine learning models such as a convolutional neural network, a Histogram of Oriented Gradients (HOG), Region-based Convolutional Neural Networks (R-CNN), Faster R-CNN, Region-based Fully Convolutional Network (R-FCN), Mask R-CNN, Single Shot Detector (SSD), You Only Look Once (YOLO) Models, RetinaNet, Blitznet, Spatial Pyramid Pooling (SPP-net), or other machine learning models capable of detecting and classifying objects in images (including LIDAR data). To illustrate, the disclosed technology can utilize a YOLOv8m model for object detection and a YOLOv8m-cls model for classification of detected objects. It will be appreciated that the disclosed technology can be implemented using various types of machine learning models and methodologies of training and implementing the machine learning models. Accordingly, the disclosed technology should not be limited to the specific machines learning models described herein.

The disclosed technology addresses this issue with systems and methods relating to identifying and/or classifying objects indicated by LIDAR data. As discussed more fully herein, the disclosed technology can be useful in several scenarios and applications. However, for the sake of brevity, the disclosed technology is primarily discussed as being used for identification, classification and/or condition assessment of utility-related equipment. Certain implementations of the disclosed technology may be utilized for inventorying the components installed on one or more utility poles, evaluating clearances, and/or mapping the location(s) of one or more components. However, it should be understood that the discussion of such use cases is not intended to limit the scope of the disclosed technology to utility-related applications.

Aspects of the disclosed technology will be described more fully hereinafter with reference to the accompanying drawings. This disclosed technology can, however, be embodied in many different forms and should not be construed as limited to the examples set forth therein.

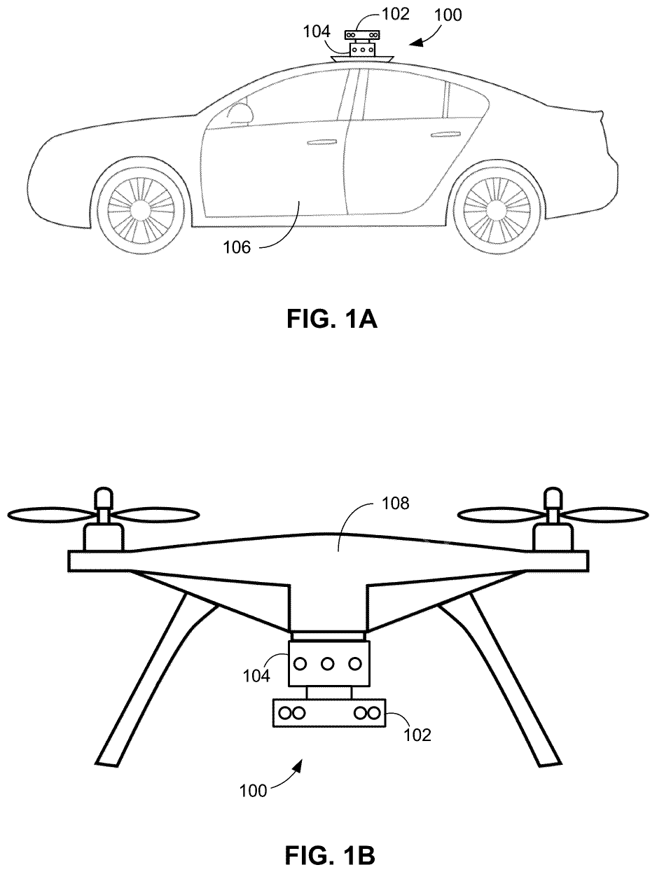

FIG. 1A illustrates an example mobile LIDAR/camera system 100 installed on a terrestrial vehicle 106 (such as a car), in accordance with an implementation of the disclosed technology. FIG. 1B illustrates an example LIDAR/camera system 100 installed on an arial vehicle 108 (such a drone or other aircraft), in accordance with certain implementations of the disclosed technology. The LIDAR/camera system 100 can include a LIDAR system 102 and a camera system 104. In accordance with certain exemplary implementations of the disclosed technology, a GNSS receiver may be included in the system 100.

In certain implementations, the system 100 can include or be attached to a be a user-carriable system, such as a backpack. The camera system 104 can include one or more lenses or other optical sensors (each referred to herein as a “camera” for simplicity). For example, the camera system 104 can include multiple cameras, and each camera can be oriented in a different radially outward direction. For example, the cameras can be positioned and oriented such that the camera system 104 can simultaneously capture camera data in multiple directions surrounding the camera system 104 (e.g., 360-degree images). It should be noted that the camera image data discussed herein generally relates to data representing images captured in the visible light spectrum. However, in certain implementations, the camera image data may be representative of images captured in other light spectrums, such as the infrared light spectrum and/or ultraviolet light spectrum.

The LIDAR system 102 can include a laser and a receiver configured to detect reflections of the beam provided by the laser (referred to herein as a “LIDAR scanner” for simplicity). The LIDAR system 102 can include multiple LIDAR scanners. Each LIDAR scanner can be oriented in a different radially outward direction. For example, the LIDAR scanners can be positioned and oriented such that the LIDAR system 102 can simultaneously capture LIDAR data in multiple directions surrounding the LIDAR system 102 (e.g., 360-degree LIDAR images). Optionally, the system 100 can include a stabilizing system, device, or mechanism, such as a gimbal, which can help decrease any blurred imaging or otherwise corrupted data captured by the LIDAR system 102 and/or camera system 104. In certain implementations, the system 100 can include one or more accelerometers that may provide speed, acceleration, and/or direction information that may be utilized to compensate for time-of-flight errors in the reflected laser pulses, particularly when the system 100 is moving or changing direction.

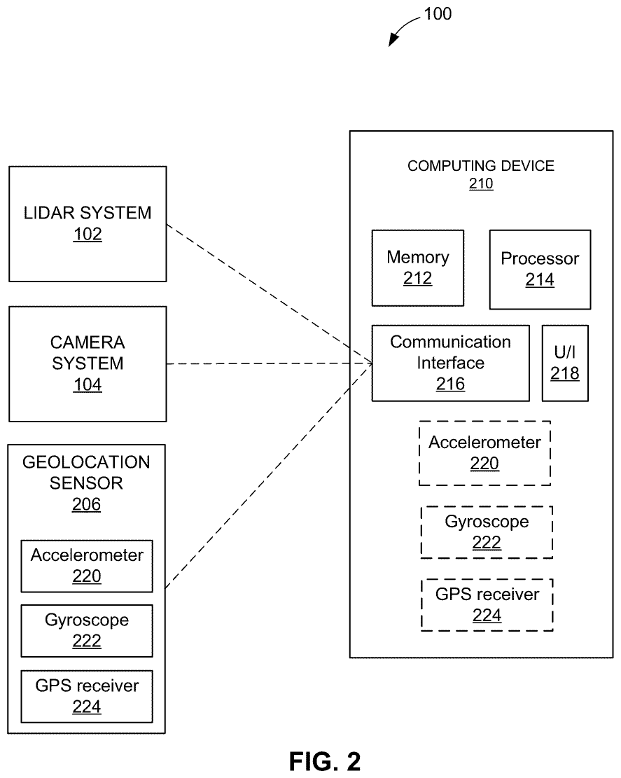

FIG. 2 illustrates a component diagram of the example LIDAR/camera system 100, in accordance with the disclosed technology. The system 100 can include a computing device 210 that includes memory 212, at least one processor 214, a communication interface 216, and a user interface 218. In certain implementations, the computing device 210 can be mobile and co-located with the LIDAR system 102, the camera system 104, and the geolocation sensor 206. In such implementations, the geolocation sensor 206 (or optionally, the computing device 210) may include an accelerometer 220, gyroscope 222, and GPS receiver 224.

As described more fully herein, the computing device 210 can receive data, such as from the LIDAR system 102, the camera system 104, and/or a geolocation sensor 206 of the system 100, and/or the computing device can output instructions to one or more components (e.g., the LIDAR system 102, the camera system 104, and/or a geolocation sensor 206). For example, the computing device 210 can perform one or more of the methods described herein or any part thereof. The computing device 210 can be or include any control or computing system, such as a dedicated controller/processor for the system 100, a locally located computing device, a remotely located computing device (e.g., backend server), and/or any combination thereof.

This disclosure references a single computing device 210 for simplicity of discussion, but the disclosed technology is not so limited. For example, multiple computing devices (e.g., a network of computing devices) can be used to perform one, some, or all the actions and/or functionalities described herein. Moreover, a first computing device can perform one or more actions and/or functionalities, and a second computing device can perform one or more other actions and/or functionalities. As a specific example, it is contemplated that a local controller may be configured to receive data from the LIDAR system 102, camera system 104, and/or geolocation sensor 206, and the controller can transmit some or all of that data to a computing device that is configured to perform some, or all of the analyses described herein. In certain implementations, the system 100 can include an accelerometer 220, a gyroscope 222, and a GPS receiver 224, which, in one embodiment, may be functionally associated with the geolocation sensor 206. In another embodiment, the accelerometer 220, gyroscope 222, and GPS receiver 224 may be functionally associated with the computing device 210. In either of these embodiments, the accelerometer 220 may provide speed and/or acceleration information and the gyroscope 222 may provide direction information that may be utilized to compensate for time-of-flight errors in the LIDAR data.

The computing device 210 can be in direct wired or wireless communication with the controller, in indirect wired or wireless communication with the controller (e.g., via a network), locally located (i.e., with respect to the controller), and/or remotely located.

The computing device 210 can communicate with one or more sensors and/or devices, via the communication interface 216, as a non-limiting example. For example, the computing device 210 can receive data from the LIDAR system 102, the camera system 104, and/or a geolocation sensor 206. The computing device 210 can output instructions to one, some, or all of these or other components (e.g., instructions to engage or disengage).

In accordance with certain exemplary implementations of the disclosed technology, the computing device 210 may be utilized to determine the speed and an orientation of a mobile LIDAR/camera system 100. In certain implementations, the computing device 210 may control the LIDAR system 102 such that it dynamically captures position data corresponding to a region of interest by collecting LIDAR samples at a rate based on the speed, the orientation, and the region of interest. In certain implementations, the computing device 210 may compensate at least a portion of the position data based on one or more of the speed and orientation to correct position errors, as discussed above and as presented in Yang, et al.

In certain implementations, the computing device 210 may provide instructions for capturing, with a camera 104, one or more images of the region of interest. In certain implementations, the computing device 210 in communication with the geolocation sensor 206, may be utilized to determine one or more locations and directions of the camera corresponding to the capturing of the one or more images. Based on the one or more locations and directions of the camera and the one or more captured images, the computing device 210 may determine the location of a utility object. In certain implementations, the computing device 210 may decimate the LIDAR samples within a selectable or predetermined area at or around the location of the utility object.

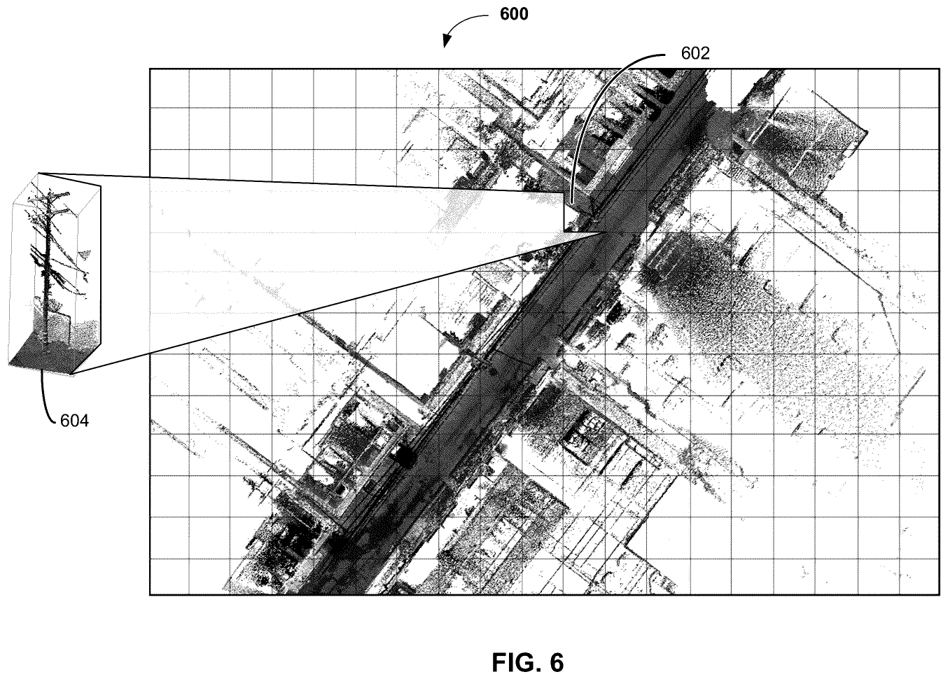

As will be discussed below with respect to FIGS. 6-9, the computing device 210 may generate depth-encoded multi-perspective images of the utility object using the decimated LIDAR samples. In accordance with certain exemplary implementations of the disclosed technology, at least one condition of the utility object may be assessed using the depth-encoded multi-perspective images. In certain implementations, the computing device 210 may output a work order, for example, to dispatch a crew to the region of interest based on the assessing of the utility object.

In certain implementations, the computing device 210 can associate current LIDAR data (e.g., received from the LIDAR system 102) and/or current camera data (e.g., received from the camera system 104) with current location data, speed data, and/or orientation data (e.g., received from the geolocation sensor 206 and associated accelerometer 220). Accordingly, the computing device 210 can associate each image with the location, speed, and direction at which the image was captured. This can be helpful in identifying the location and/or identity of a utility pole captured in the LIDAR and/or camera data and for correcting errors in the LIDAR data.

As will be described more fully herein, the LIDAR system 102 can capture LIDAR data and transmit the LIDAR data to the computing device 210. The LIDAR data can comprise and/or be indicative of a point cloud. Alternatively, the computing device 210 can create a point cloud based on the LIDAR data. As will be appreciated, a point cloud can be a data set representing points in space. Each point can have a set of coordinates (e.g., Cartesian coordinates). Thus, the points can, for example, represent a three-dimensional shape or object. As discussed elsewhere herein, this data can be useful for determining whether an object is present in a space, but existing LIDAR systems have been generally unable to identify the object with any useful specificity.

To address this issue, the system can use camera data to better identify objects. The camera system 104, for example, can capture one or more images and can transmit the corresponding camera data, which is representative of the image(s), to the computing device 210. The camera data can be representative of any type of image; as non-limiting examples, the camera data can be representative of 360-degree images, 180-degree images, fisheye images, equirectangular images, wide angle images, and/or normal/perspective images. The computing device 210 can optionally convert the camera data to a different image type. For example, the computing device 210 can convert camera data indicating fisheye images to “normal” images that reproduce a field of view that appears natural to a human observer (e.g., perspective images).

In certain implementations, the computing device 210 may perform one or more image recognition processes. For example, the computing device 210 can execute one or more object recognition algorithms and/or perform one or more image processing methods, such as Scale-Invariant Feature Transform (SIFT), Speeded Up Robust Features (SURF), Principal Component Analysis (PCA), Linear Discriminant Analysis (LDA), Region Based Convolutional Neural Networks (R-CNN), Fast R-CNN, Faster R-CNN, Mask R-CNN, Histogram of Oriented Gradients (HOG), Region-Based Fully Convolutional Network (R-FCN), simultaneous location and mapping (SLAM), Single Shot Detector (SSD), Spatial Pyramid Pooling (SPP-net), or You Only Look Once (YOLO), as non-limiting examples.

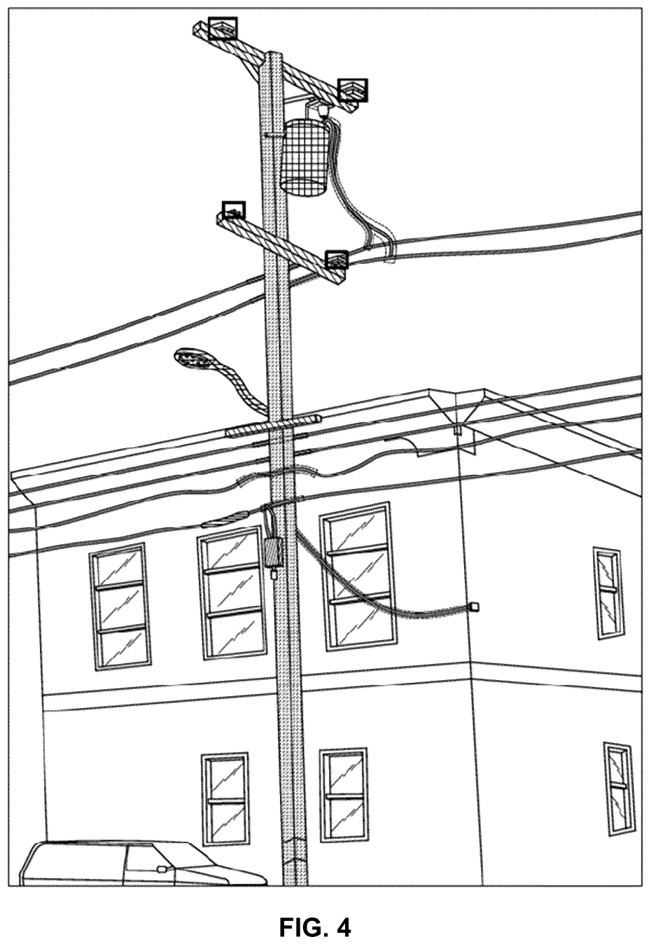

FIG. 4 illustrates an example use case of assessment of a utility pole with its associated cabling and related components that may be imaged and analyzed for various functions, including but not limited to assessing a possible need of being serviced or replaced, assessing whether room exists for adding an additional cable, assessing existing cables for placement revisions to make room for additional cables, etc. In this use case, the computing device 210 may identify and/or recognize several different components, sub-components, and the like. For example, the computing device can identify, recognize, and/or locate utility poles, crossarms, transformers, insulators, lightning arrestors, various electrical wires (e.g., primary wires, neutral wires, secondary wires, and/or ground wires), cutouts, various communication wires (e.g., telephone wires, internet wires, and/or cable wires), guy wires, lamps, and the like. Optionally, the computing device 210 can identify and/or recognize different models or types of the components, sub-components, and the like.

As illustrated in FIG. 4, the computing device 210 may also identify and/or recognize objects that are not attached to the utility pole. For example, the computing device 210 can identify and/or recognize objects that may interfere with the pole or components attached thereto (e.g., wires), such as vegetation (e.g., trees), buildings, vehicles, road signs, and other structures.

In certain implementations, the computing device 210 may be used to identify certain conditions, such as clearance between the utility object and other surrounding structures and/or other conditions that may warrant replacement, revision, or other forms of maintenance or repair. In certain implementations, the computing device 210 may assess the condition and automatically output a work order or dispatch a crew to carry out the replacement, revision, maintenance, repair, etc. In certain implementations, a model or age of a given component or sub-component may be identified by the computing device 210. In certain implementations, the computing device 210 can log or create an inventory of the devices, components, and/or sub-components.

In certain implementations, the computing device 210 can automatically output a notification to a technician device (e.g., a mobile computing device) or another device (e.g., a device for a utility pole service provider or a utility service provider) including instructions for to move one or more existing devices or components to accommodate installation of a new line, device, or the like (commonly referred to as “make ready engineering” or “MRE”). The instructions can inform the technician to move one or more existing devices or components from their respective current locations to respective new locations, thereby making room for the new line, device, or the like.

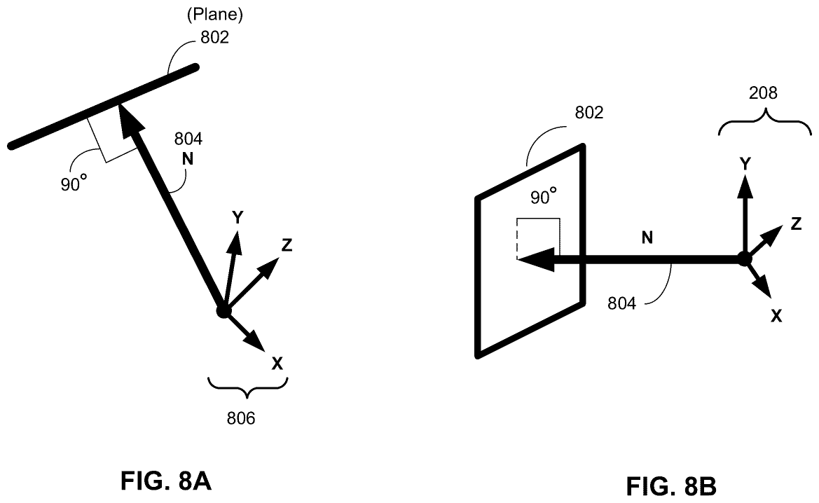

In accordance with certain exemplary implementations of the disclosed technology, the computing device 210 may be utilized to combine or align the camera data (e.g., one or more images from the camera data) with the LIDAR data. For example, the computing device 210 may map the LIDAR points to corresponding pixels in the one or more images from the camera data. As will be discussed below with reference to FIGS. 8A and 8B, the computing device 210 may encode depth information of a 3D rendering in a 2D array for creating multi-view images.

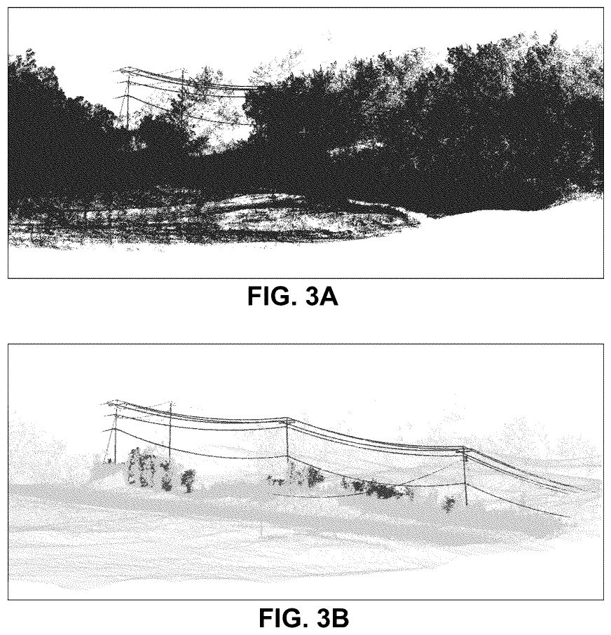

In accordance with certain exemplary implementations of the disclosed technology, the computing device 210 can create a point cloud based on the LIDAR data and/or the camera data. For example, the computing device 210 can trim or discard LIDAR points beyond a particular distance from the edge of a recognized or identified object (e.g., from the camera data), such that the resulting LIDAR data forms the point cloud of the identified object. The computing device 210 can classify LIDAR data by mapping the image recognition results from the camera data to the LIDAR data or by any other method as described herein. As a more specific example, the computing device 210 can combine or align images, such as the image depicted in FIG. 3A, with the LIDAR data and trim the LIDAR data that does not correspond to recognized or identified objects, which can result in a combined LIDAR/camera image, such as the combined LIDAR/camera image depicted in FIG. 3B, in which the utility poles and associated cables may be evaluated. In this example, the resulting image shown in FIG. 3B may be used to detect a condition of a downed cable, such as a power line.

In accordance with certain exemplary implementations of the disclosed technology, the computing device 210 can associate or map LIDAR points (or samples) to the corresponding pixels of the camera data before identifying objects and/or before creating the masks or other image segmentation elements over identified objects. However, this order of operations may result in unnecessary computations. That is, by first identifying objects and/or creating the masks or other image segmentation elements, LIDAR data that does not correspond to identified objects can be ignored or discarded at the pixel association step, which can help reduce the amount of computing required, thereby saving time and energy. For example, the computing device 210 can associate or map to the camera data only the LIDAR data corresponding to those objects present in a line corridor. Thus, the data size can be reduced, which can help enable the system 100 to more efficiently and/or effectively utilize the data of interest.

Based at least in part on the LIDAR data, the camera data, and/or the location data, the computing device 210 can create a map indicating the locations of one or more poles (e.g., a line corridor). Thus, service providers can be informed as to where the poles are located relative to customers or potential customers, which can be useful, for example, when a service provider is determining how best to develop an infrastructure for a new service. As an example, the map of pole locations can be helpful for an internet service provider in determining how best to build a broadband network to provide broadband internet to rural areas. Because the internet service provider is unlikely to know where utility poles are located, this information can be helpful for the internet service provider to determine whether it is feasible to provide internet service to its customers or potential customers via the utility poles.

Based on the LIDAR data and the camera data, the size (e.g., dimensions) of one, some, or all of the identified components may be identified. Alternatively, or in addition, the computing device 210 can determine or calculate the location of one, some, or all of the identified components. For example, for a given object installed on a utility pole, the computing device 210 can determine the height of a lowermost portion of the object and the height of the uppermost portion of the object. By determining the location of each object on the pole, the computing device 210 can determine whether and to what extent space is available on the pole for additional devices or components.

The computing device 210 can determine other aspects and attributes related to the utility pole(s). For example, the computing device 210 can determine the diameter and/or height of the utility pole. Based on the location of the pole (e.g., based on the location data received from the geolocation sensor 206), the computing device 210 can cross-reference these attributes with a pole database; accordingly, the computing device 210 can confirm or update the pole class stored in the database for the particular pole.

The computing device 210 can automatically perform a pole loading analysis based on the pole class and/or the identified components. The computing device 210 can automatically determine whether the results of the pole loading analysis comply with governing standards and regulations (e.g., based on the location data). If the pole loading analysis indicates that the current pole loading exceeds governing standards and regulations, the computing device 210 can output a notification to a device (e.g., a device for a technician, a utility pole service provider, and/or a utility service provider) indicating that the pole is experiencing excessive pole loading. The notification can instruct the technician to remove one or more devices (e.g., one or more specific devices based on their weight, for example) from the pole and/or install a new pole to accommodate one or more devices currently installed on the pole.

Based on the LIDAR data and the camera data, the computing device 210 can measure various aspects of the wires or other components extending between adjacent poles. For example, the computing device 210 can measure the span lengths between adjacent poles and/or the wire angles (e.g., the angle at which a wire leaves one pole toward another object, such as another pole). As will be appreciated, this would greatly increase the ease and accuracy of field measurements for span lengths and/or wire angles, which are traditionally measured by a technician using a laser, wheel, and protractor.

In certain implementations, the computing device 210 can model the sag of wires according to various environmental conditions, such as ambient temperature and/or humidity. Thus, the computing device 210 can determine whether the sag of the wires differs under environmental conditions different from the environmental conditions in which the wires were initially installed. The computing device 210 can compare the modeled sag to the height and location of nearby objects, governing standards and regulations, and the like. Based on this comparison, the computing device 210 can determine whether and/or to what extent a corresponding insulator or other attachment point for the wires should be moved (e.g., to accommodate different lags of sag caused by changes in environmental conditions). Alternatively or in addition, the computing device can determine whether a new pole should be installed between the instant pole and the currently adjacent pole to prevent excessive sag in the wires. The computing device 210 can output a notification to a device (e.g., a device for a technician, a utility pole service provider, and/or a utility service provider) that includes instructions for moving one or more devices or other components and/or to install a new pole, to thereby reduce sag and/or prevent excessive sag of the wires.

The user interface 218 of the computing device 210 (or a user interface of a different device, such as a technician device) can enable the technician or another user to interact with the overlaid and/or combined LIDAR and camera data. Thus, the technician or user can manually request the type of devices installed on a given pole (or multiple poles), specific measurements of one or more devices on a given pole (or multiple poles), the locations of the device(s), and other information. The user or technician can manipulate the combined LIDAR/camera data, such as moving a given device or component to a new location on the pole. In such a manner, the user or technician can alter or override proposed location changes for existing devices or components and/or a proposed pole addition that were automatically generated by the computing device 210. Upon receipt of the instructions from the technician or user, the computing device 210 can output instructions to the technician device or another device (e.g., a device for a utility pole service provider or a utility service provider) for moving or removing one or more devices or other components on the pole and/or to install a new pole.

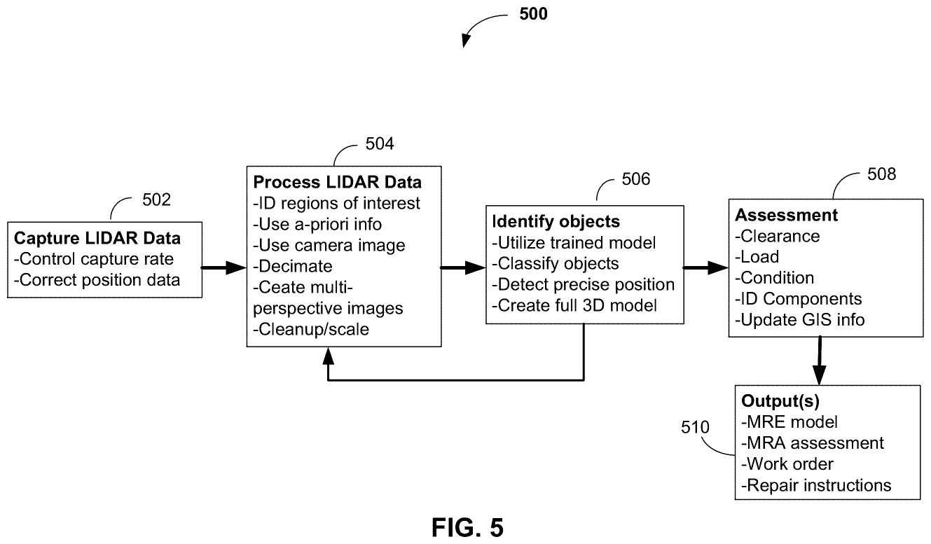

FIG. 5 illustrates a flowchart of an example process 500 for capturing and processing LIDAR data to identify and assess objects, in accordance with certain implementations of the disclosed technology. In block 502 the process 500 can include capturing LIDAR data. As discussed above, and in accordance with certain exemplary implementations of the disclosed technology, the capturing or sampling of the LIDAR data may be controlled and compensated to correct data that may have positional errors due to rapid movement or change in direction of the mobile LIDAR/camera system. In block 504, the process 500 can include processing the LIDAR data. In this stage, the captured or sampled LIDAR data may utilize a camera image, identified regions of interest, GIS data and/or other a-priori information, etc., to selectively decimate and/or mask the LIDAR data for improving the speed and efficiency of the processing, for example, by limiting the number of point cloud samples per unit grid and/or by discarding LIDAR samples that are not at or near the identified object of interest. Block 504 may also include creating multi-perspective images (as will be discussed below with reference to FIGS. 6-9). In certain implementations, block 504 may also include cleaning-up an image, for example, to remove unnecessary surrounding objects, or to emphasize objects of interest (as illustrated in FIG. 3B). In block 506, the process 500 can include identifying objects. In this block, one or more trained machine learning models may be utilized to recognize and/or classify objects of interest using the LIDAR data. In certain implementations, a precise position of the object of interest may be determined, as discussed above. In certain implementations, a 3D model of the object(s) of interest may be created. As illustrated in FIG. 5, the processes in block 506 may be fed back to the processes in block 504, for example, to create the multi-perspective images. In block 508, the example process 500 may be used to assess the object of interest. For example, clearance, load, condition, etc., of the object of interest may be assessed. In certain implementations, components may be identified. In certain implementations, GIS information may be updated based upon the assessment. In block 510, the example process may include outputting various, models, assessments, work orders, and/or instructions based on the processing by the previous blocks.

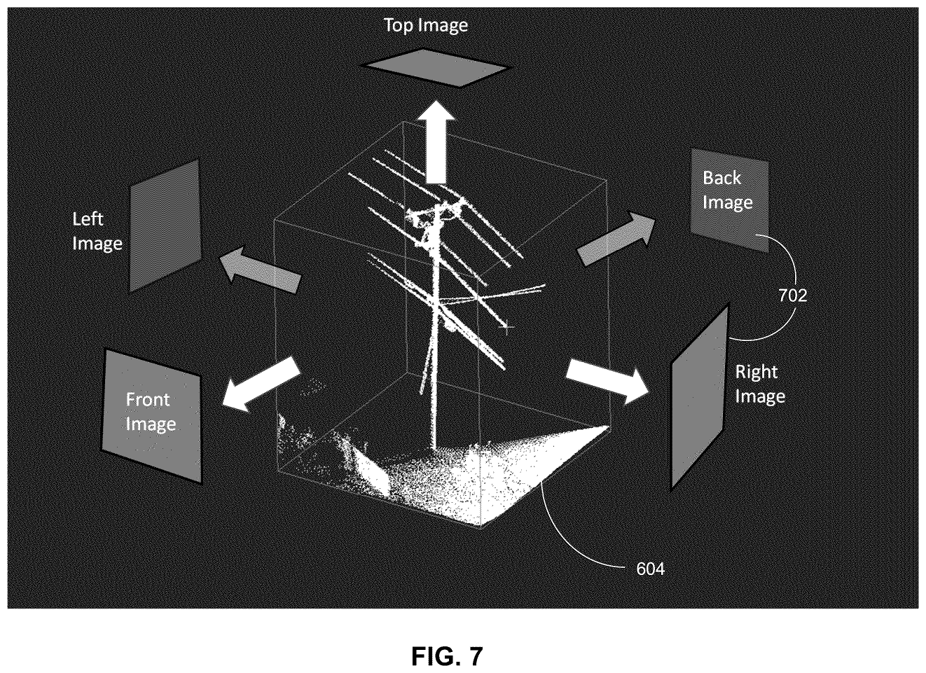

FIG. 6 illustrates a divided grid top-view aerial photograph 600 with an associated 3D rendering 604 (inset) of a utility object in one of the grid regions 602, in accordance with certain implementations of the disclosed technology. For a given scanned area (which can correspond to an area captured by the arial photograph 600), the area may be divided into 2D x-y grids (10×10 meters for example) with a corresponding +/−z direction data encoded therein. The process for creating the 3D rendering 604 and its associated 2D projections will be discussed below with respect to FIG. 7. In certain implementations, the grid sizes can be larger or smaller, and can range from about 1×1 meter extents (for high density regions of utility objects) to about 100×100 meter extents or greater (for sparsely populated regions of utility object).

In certain implementations, a grid region (for example, grid region 602) may be selected by a user and the corresponding 3D rendering of the utility object (if present in that grid region) may be displayed for review or further analysis.

FIG. 7 illustrates a multi-view 2D image 702 generation from a 3D rendering 604 of a utility object in accordance with certain exemplary implementations of the disclosed technology. Converting high-density point clouds into the multi-perspective images enables full utilization of 3D data while simultaneously leveraging the mature and efficient 2D image processing techniques.

In certain implementations, the techniques discussed above with reference to FIG. 2 may be utilized to control, decimate, mask, and convert the LIDAR scan point cloud data to a 3D rendering 604 for which 2D projections 702 may be derived.

FIG. 8A depicts a method for generating 2D projections (such as the 2D projection 702 illustrated in FIG. 7) from a 3D rendering (such as the 3D rendering 604 shown in FIGS. 6 and 7). FIG. 8A depicts a top-view representation of a plane vector N corresponding to a plane 802, in accordance with certain exemplary implementations of the disclosed technology. FIG. 8B depicts a 3D view of the plane vector N 804 of a plane 802 (as illustrated in FIG. 8A), in accordance with certain exemplary implementations of the disclosed technology. As depicted in FIG. 8A and FIG. 8B, a plane 802 may be modeled or represented by a 3D vector N 804 that is normal (perpendicular) to the plane 802. The vector N 804 may uniquely describe the plane 802 in terms of orientation and distance. In certain exemplary implementations, N 804 may start at a given point 806 of a 3D rendering (such as the 3D rendering 604 shown in FIGS. 6 and 7) and may terminate at the point of nearest approach on the surface of the plane 802.

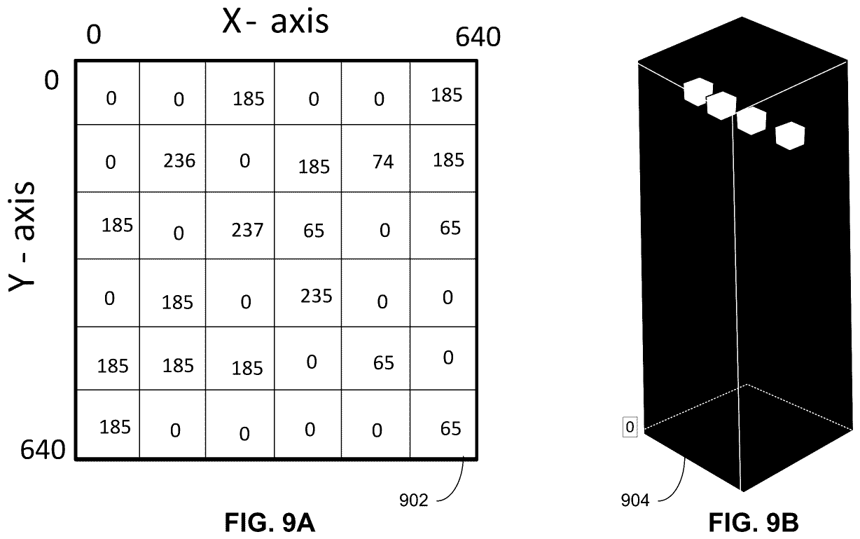

FIG. 9A illustrates a top-view vertical elevation information encoding process in which depth information of a 3D rendering may be encoded as a “z-axis” value for creating multi-view images, in accordance with certain exemplary implementations of the disclosed technology. As depicted, certain implementations of the disclosed technology may be utilized to generate grayscale images 902, each having a resolution of 640×640 pixels, and with depth information encoded into the pixels. For example, top view vertical elevation information or ‘z’ value may be transformed into a grayscale intensity ranging from 0 to 255, which may be applied to the corresponding pixel. FIG. 9A shows a 6×6 pixel image 902 for illustration purposes. It should be understood that various other resolutions may be utilized without departing from the scope of the technology.

FIG. 9B illustrates a simulated camera viewpoint 904 for a particular 3D rendering of a utility object in accordance with certain exemplary implementations of the disclosed technology. Using the 3D rendering, 2D images may then be created (as discussed above with reference to FIGS. 7, 8A, and 8B) from projections of the 3D rendering to right, left, front, back, and top planes by changing the axes. As shown in FIG. 9B, objects detected at a greater elevation will have a greater brightness (e.g., white or nearly white) while objects on or near a predefined plane will be represented with darker points (e.g., black or nearly black). The same principle can be applied to various orientations.

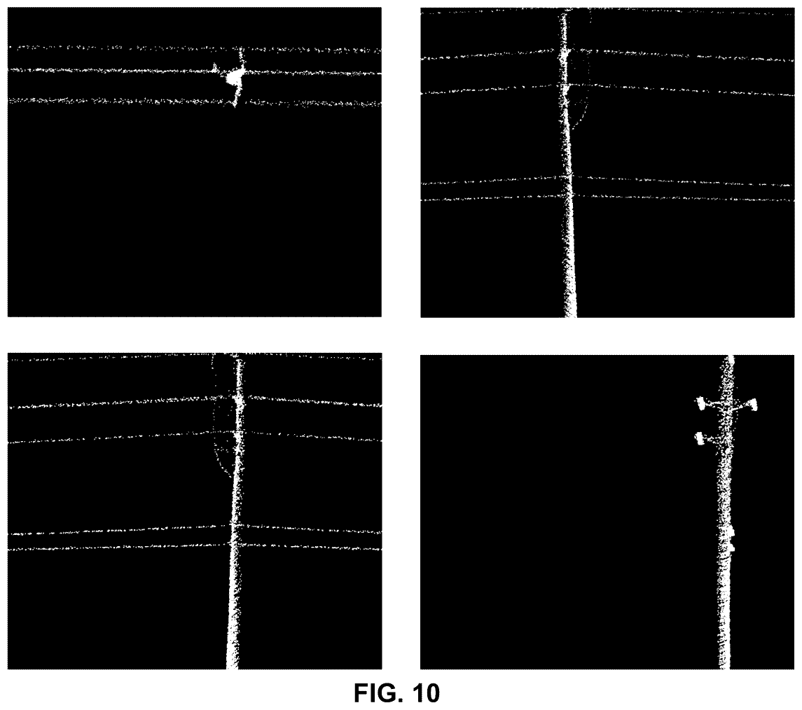

FIG. 10 shows examples of actual (2D top, back, front, and right projection) images created from point cloud grids, as discussed above with reference to FIGS. 7-9B. In accordance with certain exemplary implementations of the disclosed technology, such 2D projection images may be utilized to train one or more machine learning models (such as a YOLO model) to fine tune the model for classification and object detection purposes. In accordance with certain exemplary implementations of the disclosed technology, once the machine learning model is trained, automatic object detection and classification may be performed, for example, to recognize and catalog certain utility objects.

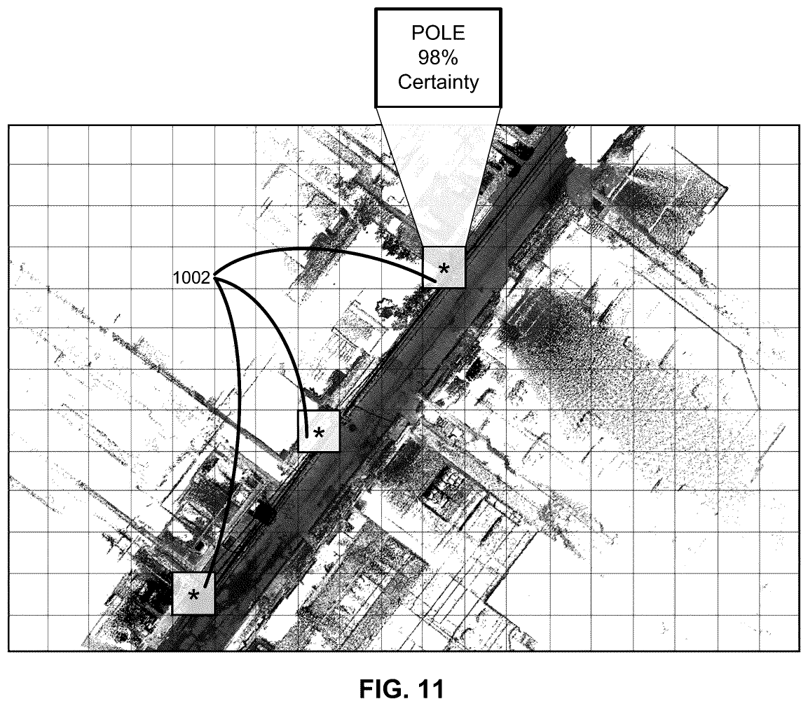

FIG. 11 illustrates a result of object detection, classification, and filtering for grids 1002 that contain a pole, in accordance with certain exemplary implementations of the disclosed technology. In a first stage, and according to certain implementations of the disclosed technology, a determined classification of the various utility objects in a region of interest may be filtered to identify grids 1002 that contain a utility pole. In a second stage, object detection may be utilized to determine a precise location of the utility pole within the (10×10 meter) grid. As illustrated, certain implementation may indicate the certainty of a particular utility object within the given grid.

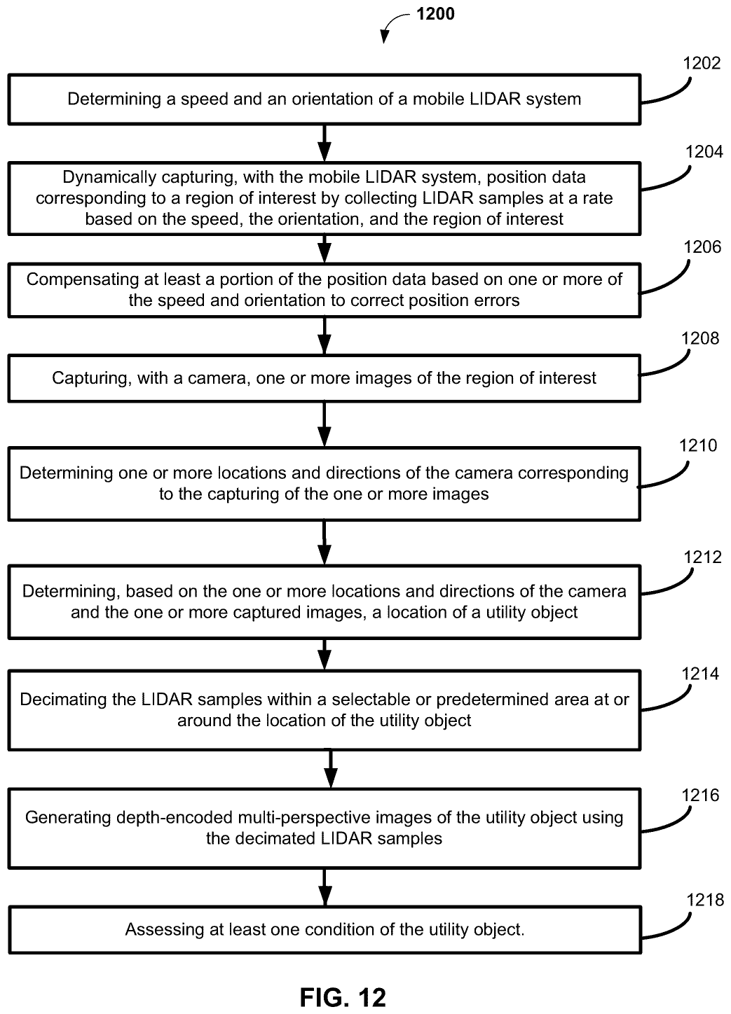

FIG. 12 illustrates a flowchart of an example method 1200 for dynamically capturing and processing utility infrastructure LIDAR data for improved assessment accuracy and processing efficiency, in accordance with certain exemplary implementations of the disclosed technology. In block 1202, the method 1200 can include determining a speed and an orientation of a mobile LIDAR system. In block 1204, the method 1200 can include dynamically capturing, with the mobile LIDAR system, position data corresponding to a region of interest by collecting LIDAR samples at a rate based on the speed, the orientation, and the region of interest. In block 1206, the method 1200 can include compensating at least a portion of the position data based on one or more of the speed and orientation to correct position errors. In block 1208, the method 1200 can include capturing, with a camera, one or more images of the region of interest. In block 1210, the method 1200 can include determining one or more locations and directions of the camera corresponding to the capturing of the one or more images. In block 1212, the method 1200 can include determining, based on the one or more locations and directions of the camera and the one or more captured images, a location of a utility object. In block 1214, the method 1200 can include decimating the LIDAR samples within a selectable or predetermined area at or around the location of the utility object. In block 1216, the method 1200 can include generating depth-encoded multi-perspective images of the utility object using the decimated LIDAR samples. In block 1218, the method 1200 can include assessing at least one condition of the utility object.

Certain implementations of the disclosed technology may further include automatically outputting a work order based on the assessment.

In certain implementations, the speed and orientation of the mobile LIDAR may be determined by using a first GPS receiver and a first accelerometer.

In certain implementations, the mobile LIDAR system can include one or more of a drone, an aircraft, and a terrestrial based LIDAR-mounted vehicle.

In accordance with certain exemplary implementations of the disclosed technology, the position data may be in the form of a point cloud.

In certain implementations, the region of interest may be selectable region. In other implementations, the region of interest may be a predetermined region.

In some implementation, the camera may be a panorama camera and the one or more images are panorama images.

In accordance with certain exemplary implementations of the disclosed technology, capturing the one of more images may be performed before, during, or after dynamically capturing the position data.

In certain implementations, the one or more locations and directions of the camera may be determined by using a second GPS receiver and a second accelerometer.

In certain implementations, determining the position of the utility object may be further based on triangulation with a determined position of the camera.

In accordance with certain exemplary implementations of the disclosed technology, determining the position of the utility object may be based on received GIS data.

Certain implementations of the disclosed technology include can include dispatching an inspector to the location of the utility object based on the assessing.

In accordance with certain exemplary implementations of the disclosed technology, dynamically capturing the position data can include adjusting the data collection rate to control point cloud density and dynamically decimating the LIDAR data based on the region of interest.

In certain implementations, dynamically decimating the LIDAR data may utilize voxel decimation to limit the number of points per grid square.

Certain implementations of the disclosed technology can include utilizing a dynamic octree spatial index in conjunction with a-priori knowledge of a geometry of structures to optimize point selection.

Certain implementations of the disclosed technology can include performing precise point positioning (PPP) around identified regions of interest.

Certain implementations of the disclosed technology can include applying pre-decimation to areas surrounding the region of interest to facilitate equipment identification.

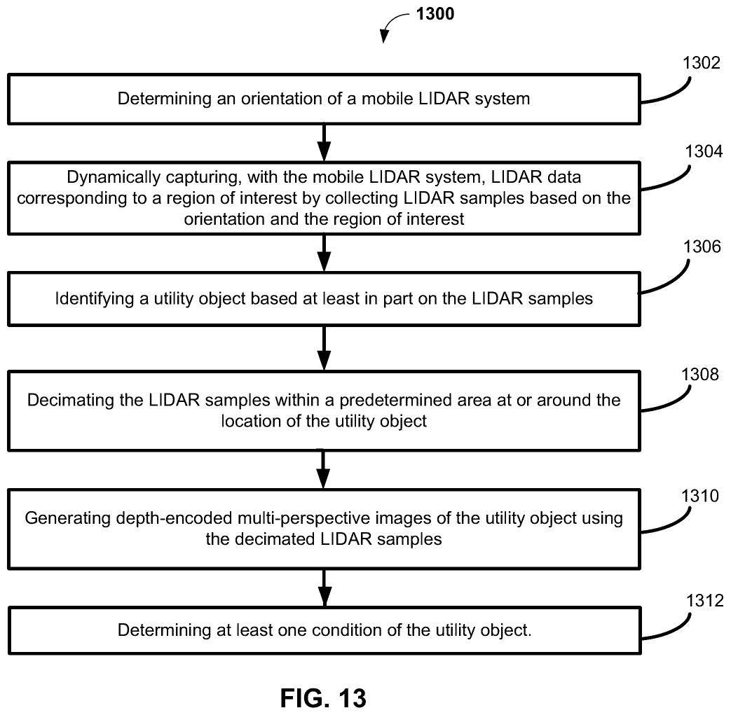

FIG. 13 illustrates a flowchart of another example method 1300 for dynamically capturing and processing utility infrastructure LIDAR data for improved assessment accuracy and processing efficiency, in accordance with certain exemplary implementations of the disclosed technology. In block 1302, the method 1300 can include determining an orientation of a mobile LIDAR system. In block 1304, the method 1300 can include dynamically capturing, with the mobile LIDAR system, LIDAR data corresponding to a region of interest by collecting LIDAR samples based on the orientation and the region of interest. In block 1306, the method 1300 can include identifying a utility object based at least in part on the LIDAR samples. In block 1308, the method 1300 can include decimating the LIDAR samples within a selectable and/or predetermined area at or around the location of the utility object. In block 1310, the method 1300 can include generating depth-encoded multi-perspective images of the utility object using the decimated LIDAR samples. In block 1312, the method 1200 can include determining at least one condition of the utility object.

Certain implementations of the disclosed technology can include determining a speed of the mobile LIDAR system and collecting the LIDAR samples at a rate based on the speed. In certain implementations, the speed of the mobile LIDAR may be determined by using a first GPS receiver. In certain implementations, the orientation of the mobile LIDAR system may be determined by using a first accelerometer.

Certain implementations of the disclosed technology can include determining an initial position of the utility object based at least in part on one or more of the LIDAR data and received GIS data.

Certain implementations of the disclosed technology can include compensating the initial position based on one or more of a speed and an orientation of the LIDAR system to correct position errors of the utility object.

Certain implementations of the disclosed technology can include capturing, with a camera, one or more images of the region of interest. Some implementations can include determining one or more positions and/or directions of the camera corresponding to the capturing of the one or more images. Certain implementations of the disclosed technology can include determining, based on the one or more positions and directions of the camera and the one or more captured images, a location of the utility object.

In certain implementations, the one or more positions and directions of the camera can be determined by using a second GPS receiver and a second accelerometer.

In certain implementations, determining the location of the utility object can be based on triangulation using a determined position of the camera.

Certain implementations of the disclosed technology can include outputting a work order based on the determining of the at least one condition of the utility object.

In certain implementations, the mobile LIDAR system can include one or more of a backpack-mounted system, a drone-mounted system, an aircraft-mounted system, and a terrestrial vehicle-mounted system.

In accordance with certain exemplary implementations of the disclosed technology, the region of interest may be a selectable or predetermined region. In certain implementations, received GIS information may be utilized, at least in part, to determine the region of interest.

In certain implementations, dynamically capturing the LIDAR data can include adjusting a data collection rate to control a point cloud density and/or dynamically decimating the LIDAR data based on the region of interest. In certain implementations, dynamically decimating the LIDAR data may utilize voxel decimation, for example, to limit a number of points per grid square.

Certain implementations of the disclosed technology can include utilizing a dynamic octree spatial index in conjunction with a-priori knowledge of a geometry of structures to optimize point selection.

Certain implementations of the disclosed technology can include performing precise point positioning (PPP) around identified regions of interest.

Certain implementations of the disclosed technology can include applying pre-decimation to areas surrounding the region of interest to facilitate equipment identification.

Certain implementations of the disclosed technology include one or more of storing the processed LIDAR data in a las format, converting 64-bit LIDAR data points near a grid center to 32-bit data, storing the processed data as a binary large object (BLOB), removing ground from images using a cloth simulation filter (CSF) algorithm, scaling the images to a predefined resolution, utilizing grayscale or HSV color space with color mapping to represent a z-position in the images, and employing one or more YOLO models for classification and object detection.

Certain implementations of the disclosed technology may include one or more of processing data from 1-meter regions in a 3-section grid using a YOLO model to identify a presence of the utility object, applying object detection to determine a precise location of the utility object; and creating a full 3D model of each utility object for assessment.

In certain implementations the utilize the YOLO modeling, point cloud data from the ground up may be divided into 3 sections of 1-meter regions and all other data may be discarded. Data from the three sections (channels) may be input to the YOLO model to detect if an object is present. In certain implementations, a first stage YOLO model may be used to feed every grid into the trained model to determine if the grid has a pole. In certain implementations, object detection may be used with selected grid to determine precise pole position within the grid.

Certain implementations of the disclosed technology may employ a decimation technique that combines a dynamic octree spatial index with a-priori knowledge of the geometry of structures of interest to perform a decimation where the points kept are a function of both their proximity to those items of interest for visualizing and determining proximity and distribution of other collected points.

As discussed herein, certain implementations may be utilized to compensate for variability in the velocity and heading of the collection path, operating performance of the collector, changes in occlusion (trees, buildings, vehicles, pedestrians, etc.), and overcollection (passing by the same structure multiple times), which can result in maximum clarity of the objects of interest with minimum noise.

As discussed herein, the disclosed technology includes systems and methods for classifying LIDAR data and/or identifying/assessing one or more objects represented by LIDAR data. The features and other aspects and principles of the disclosed technology may be implemented in various environments. Such environments and related applications may be specifically constructed for performing the various processes and operations of the disclosed technology or they may include a general-purpose computer or computing platform selectively activated or reconfigured by program code to provide the necessary functionality. Further, the processes disclosed herein may be implemented by a suitable combination of hardware, software, and/or firmware. For example, the disclosed technology may implement general purpose machines configured to execute software programs that perform processes consistent with the disclosed technology. Alternatively, the disclosed technology may implement a specialized apparatus or system configured to execute software programs that perform processes consistent with the disclosed technology. Furthermore, although some disclosed technology may be implemented by general purpose machines as computer processing instructions, all or a portion of the functionality of the disclosed technology may be implemented instead in dedicated electronics hardware.

The disclosed technology also relates to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed technology may execute high level and/or low-level software instructions, such as machine code (e.g., such as that produced by a compiler) and/or high-level code that can be executed by a processor using an interpreter.

In the foregoing description, numerous specific details have been set forth. However, it is to be understood that various examples of the disclosed technology can be practiced without these specific details. In other instances, well-known methods, structures, and techniques have not been shown in detail in order to not obscure an understanding of this description. References to “one embodiment,” “an embodiment,” “example embodiment,” “some embodiments,” “certain embodiments,” “various embodiments,” “one example,” “an example,” “some examples,” “certain examples,” “various examples,” etc., indicate that the example(s) of the disclosed technology so described can include a particular feature, structure, or characteristic, but not every implementation of the disclosed technology necessarily includes the particular feature, structure, or characteristic.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use herein of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

As used herein, the term “pole” includes various forms and definitions of elongated support members (e.g., posts, pilings), whether or not constructed of wood.

Unless otherwise specified, any range of values provided herein is inclusive of its endpoints. For example, the phrases “between 4 and 6” and “from 4 to 6” both indicate a range of values that includes 4, 6, and all values therebetween.

While certain examples of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

Certain implementations of the disclosed technology are described above with reference to block and flow diagrams of systems and methods and/or computer program products. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Although certain aspects of the disclosed technology are discussed herein in relation to a particular device or system or a particular method, it is contemplated that the disclosed technology is not so limited. To that end, any part of the devices or systems described herein can be embodied in, and/or performed as, a method and/or a non-transitory, computer-readable medium having instructions stored thereon that, when executed by a processor, cause a related device to perform the method; any part the methods described herein can be embodied in, and/or performed as, a device or system and/or a non-transitory, computer-readable medium having instructions stored thereon that, when executed by a processor, cause a related device to perform the method.

What is claimed is:

1. A method for dynamically capturing and processing utility infrastructure LIDAR data for improved assessment accuracy and processing efficiency, the method comprising:
determining an orientation of a mobile LIDAR system;
dynamically capturing, with the mobile LIDAR system, LIDAR data corresponding to a region of interest by collecting LIDAR samples based on the orientation and the region of interest;
identifying a utility object based at least in part on the LIDAR samples;
decimating the LIDAR samples within a predetermined area around the utility object;
generating depth-encoded multi-perspective images of the utility object using the decimated LIDAR samples; and
determining at least one condition of the utility object.

2. The method of claim 1, further comprising determining a speed of the mobile LIDAR system and collecting the LIDAR samples at a rate based on the speed.

3. The method of claim 2, wherein the speed of the mobile LIDAR is determined by using a first GPS receiver, and wherein the orientation of the mobile LIDAR system is determined by using a first accelerometer.

4. The method of claim 1, further comprising determining an initial position of the utility object based at least in part on one or more of the LIDAR data and GIS data.

5. The method of claim 4, further comprising compensating the initial position based on one or more of a speed and an orientation of the LIDAR system to correct position errors of the utility object.

6. The method of claim 1, further comprising:
capturing, with a camera, one or more images of the region of interest;
determining one or more positions and directions of the camera corresponding to the capturing of the one or more images; and
determining, based on the one or more positions and directions of the camera and the one or more captured images, a location of the utility object.

7. The method of claim 6, wherein the one or more positions and directions of the camera is determined by using a second GPS receiver and a second accelerometer.

8. The method of claim 6, wherein determining the location of the utility object is further based on triangulation using a determined position of the camera.

9. The method of claim 1, further comprising outputting a work order based on the determining of the at least one condition of the utility object.

10. The method of claim 1, wherein the mobile LIDAR system comprises one or more of a backpack, a drone, an aircraft, and a terrestrial based LIDAR-mounted vehicle.

11. The method of claim 1, wherein the region of interest is a selectable or predetermined region.

12. The method of claim 1, wherein dynamically capturing the LIDAR data comprises adjusting a data collection rate to control a point cloud density and dynamically decimating the LIDAR data based on the region of interest.

13. The method of claim 12, wherein dynamically decimating the LIDAR data further utilizes voxel decimation to limit a number of points per grid square.

14. The method of claim 13, further comprising utilizing dynamic octree spatial index in conjunction with a-priori knowledge of a geometry of structures to optimize point selection.

15. The method of claim 1, further comprising performing precise point positioning (PPP) around identified regions of interest.

16. The method of claim 1, further comprising applying pre-decimation to areas surrounding the region of interest to facilitate equipment identification.

17. The method of claim 1, further comprising one or more of:
storing the processed LIDAR data in a las format;
converting 64-bit LIDAR data points near a grid center to 32-bit data;
storing the processed LIDAR data as a binary large object (BLOB);
removing ground from images using a cloth simulation filter (CSF) algorithm;
scaling the images to a predefined resolution;
utilizing grayscale or HSV color space with color mapping to represent a z-position in the images; and
employing one or more Yolo models for classification and object detection.

18. The method of claim 1, further comprising one or more of:
processing data from regions in a 3-section grid using a Yolo model to identify a presence of the utility object;
applying object detection to determine a precise location of the utility object; and
creating a full 3D model of each utility object for assessment.

19. A non-transitory computer-readable storage medium storing instructions that are configured to cause one or more processors to perform a method of:
determining an orientation of a mobile LIDAR system;
dynamically capturing, with the mobile LIDAR system, LIDAR data corresponding to a region of interest by collecting LIDAR samples based on the orientation and the region of interest;
identifying a utility object based at least in part on the LIDAR samples;
decimating the LIDAR samples within a predetermined area around the utility object;
generating depth-encoded multi-perspective images of the utility object using the decimated LIDAR samples; and
determining at least one condition of the utility object.

20. The non-transitory computer-readable storage medium of claim 19, wherein the instructions further cause the one or more processor to:
determine a speed of the mobile LIDAR system;
collect the LIDAR samples at a rate based on the speed;
adjust a data collection rate to control a point cloud density; and
dynamically decimate the LIDAR data based on the region of interest.
